(19) United States
(12) Patent Application Publication
(10) Pub. No.: US 2026/0323704 A1
(43) Pub. Date: Oct. 15, 2026

(54) TRANSMISSION METHOD FOR PHYSICAL RANDOM ACCESS CHANNEL (PRACH), COMMUNICATION APPARATUS, AND STORAGE MEDIUM

(71) Applicant: Beijing Xiaomi Mobile Software Co., Ltd., Beijing (CN)

(72) Inventor: Kaiyue YAN, Beijing (CN)

(73) Assignee: Beijing Xiaomi Mobile Software Co., Ltd., Beijing (CN)

(21) Appl. No.: 18/724,384

(22) PCT Filed: Dec. 28, 2021
(86) PCT No.: PCT/CN2021/142187

§ 371 Date: Jun. 26, 2024

(51) Int. Cl. H04W 74/0833; H04W 76/40

(52) U.S. Cl. CPC H04W 74/0833; H04W 76/40

(57) ABSTRACT

Disclosed in the embodiments of the present disclosure are a transmission method and apparatus for a physical random access channel (PRACH), which method and apparatus are applied to the technical field of communications. The method executed by a user equipment comprises: determining the number of repetitions of a PRACH, and transmitting the PRACH according to the number of repetitions. In this way, the user equipment can realize the PRACH transmission of a number of repetitions, thereby enhancing the coverage of the PRACH.

### CROSS-REFERENCE TO RELATED APPLICATIONS

The present disclosure is a U.S. national phase of PCT Application No. PCT/CN2021/142187 filed on Dec. 28, 2021, the content of which is hereby incorporated by reference in its entirety.

### TECHNICAL FIELD

The present disclosure relates to a field of a communication technology, and in particular, to transmission methods for a physical random access channel (PRACH), communication apparatuses, and a storage medium.

### BACKGROUND

A random access technology is a key technology in a mobile communication system. A terminal device (or user equipment, UE) establishes a communication connection with a network-side device by the random access technology, to complete subsequent interaction operations (for example, a call, a resource request, data transmission, etc.).

### SUMMARY

Embodiment of the present disclosure provides transmission methods for a PRACH, communication apparatuses, and a storage medium.

In a first aspect, an embodiment of the present disclosure provides a transmission method for a PRACH. The method is executed by a terminal device, and the method includes: determining the number of repetitions of a PRACH; and executing PRACH transmission according to the number of repetitions.

In a second aspect, an embodiment of the present disclosure provides another transmission method for a PRACH. The method is executed by a network-side device, and the method includes: instructing the number of repetitions of the PRACH to a terminal device, and receiving data of PRACH transmission executed by the terminal device according to the number of repetitions.

In a third aspect, an embodiment of the present disclosure provides a communication apparatus. The communication apparatus includes a processor and a memory, the memory stores a computer program, and the processor executes the computer program stored in the memory, to cause the communication apparatus to execute the method in the first aspect.

In a fourth aspect, an embodiment of the present disclosure provides a communication apparatus. The communication apparatus includes a processor and a memory, the memory stores a computer program, and the processor executes the computer program stored in the memory, to cause the communication apparatus to execute the method in the second aspect.

In a fifth aspect, an embodiment of the present disclosure provides a computer readable storage medium, configured to store instructions used for the above terminal. When the instructions are executed, the terminal device executes the method in the first aspect.

### BRIEF DESCRIPTION OF DRAWINGS

In order to more clearly illustrate technical solutions in the embodiments of the present disclosure or technical solutions in the background, the accompanying drawings that need to be used in the embodiments of the present disclosure or the background will be described below.

FIG. 1 is a schematic architectural diagram of a communication system provided by an embodiment of the present disclosure.

FIG. 2 is a flowchart of a transmission method for a PRACH provided by an embodiment of the present disclosure.

FIG. 3 is another flowchart of a transmission method for a PRACH provided by an embodiment of the present disclosure.

FIG. 4 is still another flowchart of a transmission method for a PRACH provided by an embodiment of the present disclosure.

FIG. 5 is still another flowchart of a transmission method for a PRACH provided by an embodiment of the present disclosure.

FIG. 6 is still another flowchart of a transmission method for a PRACH provided by an embodiment of the present disclosure.

FIG. 7 is still another flowchart of a transmission method for a PRACH provided by an embodiment of the present disclosure.

FIG. 8 is still another flowchart of a transmission method for a PRACH provided by an embodiment of the present disclosure.

FIG. 9 is a structural diagram of a communication apparatus provided by an embodiment of the present disclosure.

FIG. 10 is another structural diagram of a communication apparatus provided by an embodiment of the present disclosure.

FIG. 11 is still another structural diagram of a communication apparatus provided by an embodiment of the present disclosure.

FIG. 12 is a schematic structural diagram of a chip provided by an embodiment of the present disclosure.

### DETAILED DESCRIPTION

In order to better understand transmission methods for a physical random access channel (PRACH) disclosed in the embodiments of the present disclosure, a communication system applied to the embodiments of the present disclosure is described firstly below.

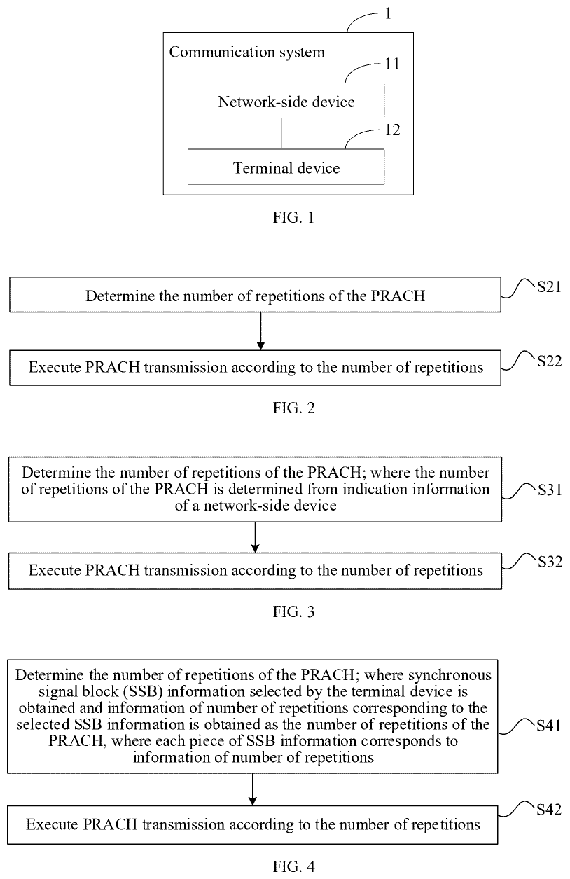

Referring to FIG. 1, FIG. 1 is a schematic architectural diagram of a communication system 1 provided by an embodiment of the present disclosure. The communication system may include, but is not limited to, one network-side device and one terminal device. The number of devices and forms of the devices shown in FIG. 1 are only exemplary and do not constitute limitations to the embodiments of the present disclosure. In a practical application, the communication system may include two or more network-side devices and two or more terminal devices. For example, the communication system 1 shown in FIG. 1 includes one network-side device 11 and one terminal device 12.

It should be noted that technical solutions of the embodiments of the present disclosure may be applied to various types of communication systems, for example, a long term evolution (LTE) system, a 5-th generation (5G) mobile communication system, a 5G new radio (NR) system, or other future new mobile communication systems, etc.

The network-side device 11 in the embodiments of the present disclosure is an entity for sending or receiving a signal on a network-side. For example, the network-side device 11 may be an evolved NodeB (eNB), a transmission reception point (TRP), a next generation NodeB (gNB) in an NR system, a base station in other future mobile communication systems, an access node in a wireless fidelity (WiFi) system, etc. Specific technologies and specific device forms used by the network-side device are not limited in the embodiments of the present disclosure. The network-side device provided in the embodiments of the present disclosure may be composed of a central unit (CU) and a distributed unit (DU). The CU may also be referred to as a control unit. A protocol layer of the network-side device, for example a base station, may be split by using a structure of a CU-DU. Functions of a part of the protocol layer are centrally controlled by the CU, and functions of the remaining part or all of the protocol layer are distributed in the DU, such that the CU centrally controls the DU.

The terminal device 12 in the embodiments of the present disclosure is an entity for receiving or sending a signal on a user-side, for example a mobile phone. The terminal device may also be referred to as a terminal, user equipment (UE), a mobile station (MS), a mobile terminal (MT), etc. The terminal device may be a car with a communication function, a smart car, a mobile phone, a wearable device, a Pad, a computer with a wireless transceiving function, a virtual reality (VR) terminal device, an augmented reality (AR) terminal device, a wireless terminal device in industrial control, a wireless terminal device in self-driving, a wireless terminal device in a remote medical surgery, a wireless terminal device in a smart grid, a wireless terminal device in transportation safety, a wireless terminal device in a smart city, a wireless terminal device in a smart home, etc. Specific technologies and specific device forms used by the terminal device are not limited in the embodiment of the present disclosure.

It may be understood that the communication system described in the embodiments of the present disclosure is to describe the technical solutions in the embodiments of the present disclosure more clearly, and does not constitute a limitation on the technical solutions provided in the embodiments of the present disclosure. Those skilled in the art may know that with evolution of system architectures and emergence of new business scenarios, the technical solutions provided in the embodiments of the present disclosure are also applicable to similar technical problems.

Transmission methods and apparatuses for a physical random access channel (PRACH) provided by the present disclosure will be described in detail below with reference to the accompanying drawings.

Referring to FIG. 2, FIG. 2 is a flowchart of a transmission method for a PRACH provided by an embodiment of the present disclosure.

As shown in FIG. 2, the method is executed by a terminal device, and the method may include but is not limited to the following steps S21-S22.

At step S21, the number of repetitions of the PRACH is determined.

At step S22, PRACH transmission is executed according to the number of repetitions.

It may be understood that when the terminal device executes the PRACH transmission, the terminal device does not establish an RRC (radio resource control) connection to the network-side device. In this case, the network-side device cannot instruct the number of repetitions by the RRC connection or a terminal device-specific PDCCH (physical downlink control channel).

In some embodiments, the number of repetitions of the PRACH is determined by a protocol provision.

In the embodiments of the present disclosure, the terminal device can determine the number of repetitions of the PRACH according to a protocol agreement, and then execute the PRACH transmission according to the determined number of repetitions of the PRACH.

In an exemplary embodiment, the number of repetitions of the PRACH determined by the protocol provision is a fixed value, for example, the fixed value is 8; and the terminal device can determine the number of repetitions of the PRACH as 8 according to the protocol provision. Therefore, according to the determined number 8 of repetitions of the PRACH, the PRACH transmission may be repeatedly executed for 8 times.

Based on this, in the embodiment of the present disclosure, the terminal device determines the number of repetitions of the PRACH. The number of repetitions of the PRACH is determined by the protocol provision, and the PRACH transmission is executed according to the determined number of repetitions of the PRACH. Therefore, the terminal device determines the number of repetitions of the PRACH transmission, to implement the PRACH transmission for the number of repetitions, to enhance coverage of the PRACH.

Referring to FIG. 3, FIG. 3 is another flowchart of a transmission method for a PRACH provided by an embodiment of the present disclosure.

As shown in FIG. 3, the method is executed by a terminal device, and the method may include but is not limited to the following steps S31-S32.

At step S31, the number of repetitions of the PRACH is determined; where the number of repetitions of the PRACH is determined by indication information of a network-side device.

At step S32, PRACH transmission is executed according to the number of repetitions.

In the embodiments of the present disclosure, the terminal device can determine the number of repetitions of the PRACH according to the indication information of the network-side device, and then execute the PRACH transmission according to the determined number of repetitions of the PRACH.

In some embodiments, the indication information of the network-side device indicates that the number of repetitions of the PRACH is a preset value.

In an exemplary embodiment, the indication information of the network-side device indicates that the number of repetitions of the PRACH is a preset value 8; and the terminal device can determine the number of repetitions of the PRACH as 8 according to the indication information of the network-side device. Therefore, according to the determined number 8 of repetitions of the PRACH, the PRACH transmission may be repeatedly executed for 8 times.

In some other embodiments, the terminal device determines a candidate value set, and selects the number of repetitions from the candidate value set according to the indication information of the network-side device.

In an exemplary embodiment, the terminal device determines a candidate value set as {2, 4, 8}, and selects the number 4 of repetitions from the candidate value set according to the indication information of the network-side device. The terminal device can determine the number of repetitions of the PRACH as 4 according to the indication information of the network-side device. Therefore, according to the determined number 4 of repetitions of the PRACH, the PRACH transmission may be repeatedly executed for 4 times.

In still other embodiments, the terminal device obtains a random access configuration table, where the random access configuration table includes information of number of repetitions; and the terminal device obtains, according to an index value indicated by the indication information, the number of repetitions from the random access configuration table.

In an exemplary embodiment, the random access configuration table is extended to add data including information of number of repetitions, and the number of repetitions is obtained from the random access configuration table by using the indication information of the network-side device as an index value of the random access configuration table, to determine the number of repetitions of the PRACH.

In some embodiments, the indication information is carried by a master information block (MIB) of a physical broadcast channel (PBCH), a system information block (SIB1), or an additional payload of the PBCH.

In some embodiments, the indication information is carried in an existing bit field of the MIB or the SIB1, or carried in an extended bit field of the MIB or the SIB1.

In the embodiment of the present disclosure, the indication information of the network-side device may be carried by a master information block (MIB) on a PBCH (physical broadcast channel). The indication information is carried in an existing bit field of the MIB or carried in an extended bit field of the MIB.

In the embodiment of the present disclosure, the indication information of the network-side device may be carried by an additional payload of the PBCH.

In the embodiment of the present disclosure, the indication information of the network-side device may be carried by a system information block (or system information block 1, SIB1). The indication information is carried in an existing bit field of the system information block (SIB1) or carried in an extended bit field of the system information block (SIB1).

Based on this, in the embodiment of the present disclosure, the terminal device determines the number of repetitions of the PRACH. The number of repetitions of the PRACH is determined by the indication information of the network-side device, and the PRACH transmission is executed according to the determined number of repetitions of the PRACH. Therefore, the terminal device determines the number of repetitions of the PRACH transmission, to implement the PRACH transmission for the number of repetitions, to enhance coverage of the PRACH.

Referring to FIG. 4, FIG. 4 is still another flowchart of a transmission method for a PRACH provided by an embodiment of the present disclosure.

As shown in FIG. 4, the method is executed by a terminal device, and the method may include but is not limited to the following steps S41-S42.

At step S41, the number of repetitions of the PRACH is determined; where synchronous signal block (SSB) information selected by the terminal device is obtained, where each piece of SSB information corresponds to information of number of repetitions; and information of number of repetitions corresponding to the selected SSB information is obtained as the number of repetitions of the PRACH.

At step S42, PRACH transmission is executed according to the number of repetitions.

In the embodiment of the present disclosure, the terminal device can obtain, according to the selected SSB (synchronous signal block) information, information of number of repetitions corresponding to the selected SSB information as the number of repetitions of the PRACH, to determine the number of repetitions of the PRACH, and then execute the PRACH transmission according to the determined number of repetitions of the PRACH. The terminal device may select an optimal SSB with stronger channel quality. A specific selection manner may be based on existing methods. Therefore, binding between the number of repetitions and the SSB information is only limited in the embodiment of the present disclosure.

In the embodiment of the present disclosure, the number of repetitions of the PRACH may be bound to an SSB beam, and each of SSB beams corresponds to information of number of repetitions. In the case that the terminal device selects a downlink SSB beam, the terminal device can implicitly obtain the number of repetitions of the PRACH, according to the information of number of repetitions corresponding to the selected SSB beam.

Based on this, in the embodiment of the present disclosure, the terminal device determines the number of repetitions of the PRACH. The terminal device obtains synchronous signal block (SSB) information selected by the terminal device, where each piece of SSB information corresponds to information of number of repetitions, obtains information of number of repetitions corresponding to the selected SSB information as the number of repetitions of the PRACH, and executes the PRACH transmission according to the determined number of repetitions of the PRACH. Therefore, the terminal device determines the number of repetitions of the PRACH transmission, to implement the PRACH transmission for the number of repetitions, to enhance coverage of the PRACH.

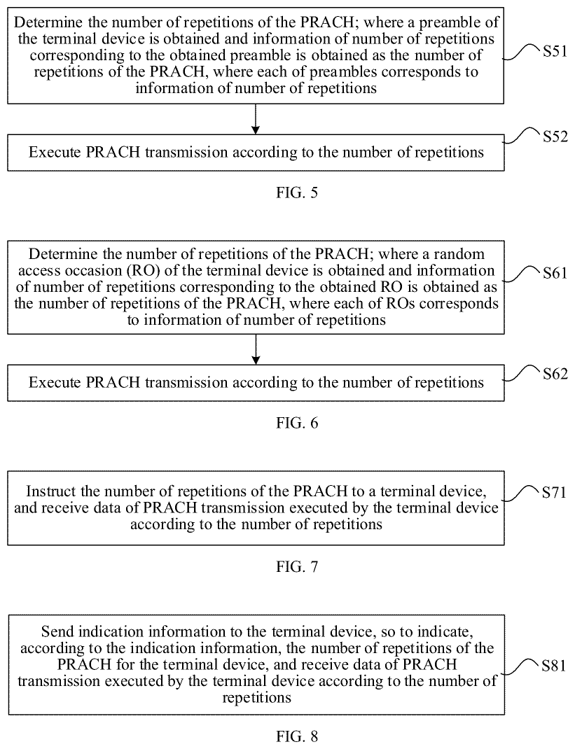

Referring to FIG. 5, FIG. 5 is still another flowchart of a transmission method for a PRACH provided by an embodiment of the present disclosure.

As shown in FIG. 5, the method is executed by a terminal device, and the method may include but is not limited to the following steps S51-S52.

At step S51, the number of repetitions of the PRACH is determined; where a preamble of the terminal device is obtained, where each of preambles corresponds to information of number of repetitions; and information of number of repetitions corresponding to the preamble is obtained as the number of repetitions of the PRACH.

At step S52, PRACH transmission is executed according to the number of repetitions.

In the embodiment of the present disclosure, the terminal device can obtain, according to the selected preamble, information of number of repetitions corresponding to the selected preamble as the number of repetitions of the PRACH, to determine the number of repetitions of the PRACH, and then execute the PRACH transmission according to the determined number of repetitions of the PRACH.

In the embodiment of the present disclosure, the number of repetitions of the PRACH may be bound to a PRACH preamble. Preambles are grouped, and a certain group of preambles corresponds to a fixed number of repetitions. In the case that the terminal device selects a preamble, the terminal device can implicitly obtain the number of repetitions of the PRACH, according to the information of number of repetitions corresponding to the selected preamble.

Based on this, in the embodiment of the present disclosure, the terminal device determines the number of repetitions of the PRACH. The terminal device obtains a preamble of the terminal device, where each of preambles corresponds to information of number of repetitions, obtains information of number of repetitions corresponding to the preamble as the number of repetitions of the PRACH, and executes the PRACH transmission according to the determined number of repetitions of the PRACH. Therefore, the terminal device determines the number of repetitions of the PRACH transmission, to implement the PRACH transmission for the number of repetitions, to enhance coverage of the PRACH.

Referring to FIG. 6, FIG. 6 is still another flowchart of a transmission method for a PRACH provided by an embodiment of the present disclosure.

As shown in FIG. 6, the method is executed by a terminal device, and the method may include but is not limited to the following steps S61-S62.

At step S61, the number of repetitions of the PRACH is determined; where a random access occasion (RO) of the terminal device is obtained, where each of ROs corresponds to information of number of repetitions; and information of number of repetitions corresponding to the RO is obtained as the number of repetitions of the PRACH.

At step S62, PRACH transmission is executed according to the number of repetitions.

In the embodiment of the present disclosure, the terminal device can obtain, according to the selected random access occasion (or RACH occasion, RO), information of number of repetitions corresponding to the selected RO as the number of repetitions of the PRACH, to determine the number of repetitions of the PRACH, and then execute the PRACH transmission according to the determined number of repetitions of the PRACH.

In the embodiment of the present disclosure, the number of repetitions of the PRACH may be bound to an RO. A certain RO or multiple ROs correspond to a fixed number of repetitions. In the case that the terminal device selects an RO, the terminal device can implicitly obtain the number of repetitions of the PRACH, according to the information of number of repetitions corresponding to the selected RO.

Based on this, in the embodiment of the present disclosure, the terminal device determines the number of repetitions of the PRACH. The terminal device obtains a random access occasion (RO) of the terminal device, where each of ROs corresponds to information of number of repetitions, obtains information of number of repetitions corresponding to the RO as the number of repetitions of the PRACH, and executes the PRACH transmission according to the determined number of repetitions of the PRACH. Therefore, the terminal device determines the number of repetitions of the PRACH transmission, to implement the PRACH transmission for the number of repetitions, to enhance coverage of the PRACH.

Referring to FIG. 7, FIG. 7 is still another flowchart of a transmission method for a PRACH provided by an embodiment of the present disclosure.

As shown in FIG. 7, the method is executed by a network-side device, and the method may include but is not limited to the following step S71.

At step S71, the number of repetitions of the PRACH is instructed to a terminal device, and data of PRACH transmission executed by the terminal device according to the number of repetitions is received.

It may be understood that when the terminal device executes the PRACH transmission, the terminal device does not establish an RRC (radio resource control) connection to the network-side device. In this case, the network-side device cannot instruct the number of repetitions by the RRC connection or a terminal device-specific PDCCH (physical downlink control channel).

By implementing the embodiment of the present disclosure, the number of repetitions of the PRACH for the terminal device is determined, so that the terminal device can execute the PRACH transmission according to the determined number of repetitions of the PRACH, to enhance coverage of the PRACH.

Referring to FIG. 8, FIG. 8 is still another flowchart of a transmission method for a PRACH provided by an embodiment of the present disclosure.

As shown in FIG. 8, the method is executed by a network-side device, and the method may include but is not limited to the following step S8.

At step S81, indication information is sent to the terminal device, so to indicate, according to the indication information, the number of repetitions of the PRACH for the terminal device, and data of PRACH transmission executed by the terminal device according to the number of repetitions is received.

In some embodiments, the indication information is sent to the terminal device, so to indicate, according to a preset value indicated by the indication information, that the number of repetitions of the PRACH is the preset value.

In some other embodiments, the indication information is sent to the terminal device, so to enable selecting, according to the indication information, the number of repetitions from the candidate value set.

In some other embodiments, the indication information indicating an index value is sent to the terminal device, so to enable obtaining, according to the index value, the number of repetitions from a random access configuration table.

In some embodiments, the indication information is carried by a master information block (MIB) of a physical broadcast channel (PBCH), a system information block (SIB1), or an additional payload of the PBCH.

In some embodiments, the indication information is carried in an existing bit field of the MIB or the SIB1, or carried in an extended bit field of the MIB or the SIB1.

Detailed description of the step S81 in the embodiment of the present disclosure may refer to related description in the above examples of the present disclosure, which will be not repeated herein.

In the embodiments provided by the present disclosure, the methods provided by the embodiments of the present disclosure are introduced from the perspectives of the network-side device and the terminal device respectively. To implement various functions in the methods provided in the embodiments of the present disclosure, the network-side device and the terminal device may include a hardware structure and a software module, to implement the above functions in a form of the hardware structure, the software module, or a combination of the hardware structure and the software module. A certain function in the above functions may be executed in a form of a hardware structure, a software module, or a combination of the hardware structure and the software module.

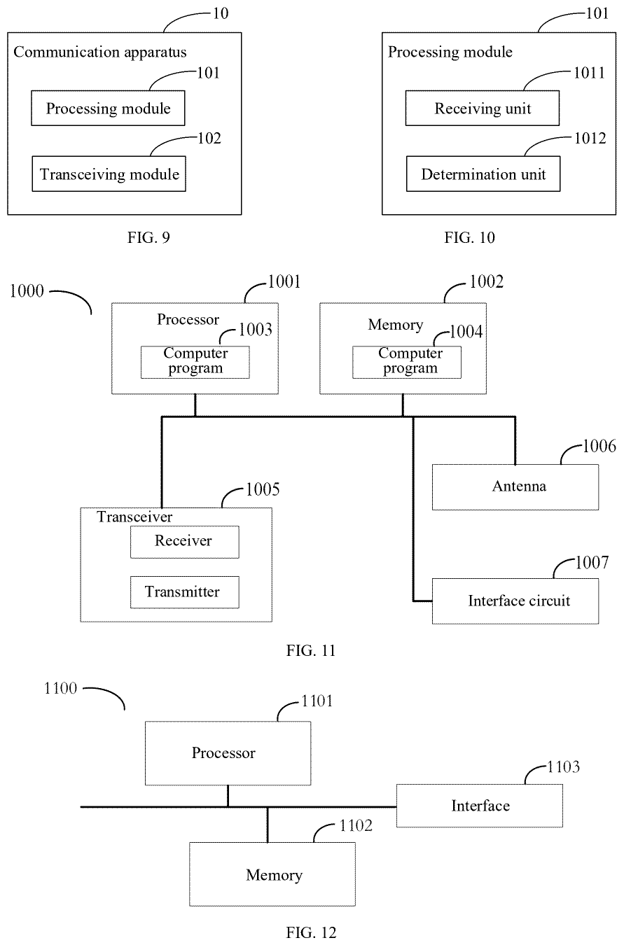

Referring to FIG. 9, FIG. 9 is a schematic structural diagram of a communication apparatus 10 provided by an embodiment of the present disclosure. The communication apparatus 10 shown in FIG. 9 may include a transceiving module 102. The transceiving module 102 may include a sending module and/or a receiving module. The sending module is configured to implement a sending function, the receiving module is configured to implement a receiving function, and the transceiving module 102 may implement the sending function and/or the receiving function.

The communication apparatus 10 may be a terminal device, may be an apparatus in the terminal device, or may be an apparatus that can be matched with the terminal device for use. Alternatively, the communication apparatus 10 may be a network-side device, may be an apparatus in the network-side device, or may be an apparatus that can be matched with the network-side device for use.

The communication apparatus 10 is a terminal device.

The apparatus includes: a processing module 101, configured to determine the number of repetitions of the PRACH; and a transceiving module 102, configured to execute PRACH transmission according to the number of repetitions.

In some embodiments, the processing module 101 is specifically configured to determine the number of repetitions of the PRACH according to a protocol provision.

As shown in FIG. 10, in some embodiments, the processing module 101 includes a receiving unit 1011 and a determination unit 1012.

The receiving unit 1011 is configured to receive indication information from the network-side device.

The determination unit 1012 is configured to determine the number of repetitions of the PRACH according to the indication information.

In some embodiments, the determination unit 1012 is specifically configured to determine the number of repetitions of the PRACH as a preset value; where the indication information indicates that the number of repetitions of the PRACH is the preset value.

In some embodiments, the determination unit 1012 is specifically configured to determine a candidate value set, and selects the number of repetitions from the candidate value set according to the indication information.

In some embodiments, the determination unit 1012 is specifically configured to obtain a random access configuration table, where the random access configuration table includes information of number of repetitions; and obtain, according to an index value indicated by the indication information, the number of repetitions from the random access configuration table.

In some embodiments, the indication information is carried by a master information block (MIB) of a physical broadcast channel (PBCH), a system information block (SIB1), or an additional payload of the PBCH.

In some embodiments, the indication information is carried in an existing bit field of the MIB or the SIB1, or carried in an extended bit field of the MIB or the SIB1.

In some embodiments, the processing module 101 is specifically configured to obtain synchronous signal block (SSB) information selected by the terminal device, where each piece of SSB information corresponds to information of number of repetitions; and obtain information of number of repetitions corresponding to the selected SSB information as the number of repetitions of the PRACH.

In some embodiments, the processing module 101 is specifically configured to obtain a preamble of the terminal device, where each of preambles corresponds to information of number of repetitions; and obtain information of number of repetitions corresponding to the preamble as the number of repetitions of the PRACH.

In some embodiments, the processing module 101 is specifically configured to obtain a random access occasion (RO) of the terminal device, where each of ROs corresponds to information of number of repetitions; and obtain information of number of repetitions corresponding to the RO as the number of repetitions of the PRACH.

Continuing to refer to FIG. 9, the communication apparatus 10 is a network-side device.

The apparatus includes: a processing module 101, configured to indicate the number of repetitions of a PRACH for a terminal device, and receive data of PRACH transmission executed by the terminal device according to the number of repetitions.

In some embodiments, the communication apparatus 10 further includes a transceiving module 102.

The transceiving module 102 is configured to send indication information to the terminal device, to indicate, according to the indication information, the number of repetitions of the PRACH for the terminal device.

In some embodiments, the transceiving module 102 is specifically configured to send the indication information to the terminal device, to select, according to the indication information, the number of repetitions from the candidate value set.

In some embodiments, the transceiving module 102 is specifically configured to send the indication information indicating an index value to the terminal device, to obtain, according to the index value, the number of repetitions from a random access configuration table.

In some embodiments, the indication information is carried by a master information block (MIB) of a physical broadcast channel (PBCH), or a system information block (SIB1).

In some embodiments, the indication information is carried in an existing bit field of the MIB or the SIB1, or carried in an extended bit field of the MIB or the SIB1.

Specific manners in which each of the modules of the communication apparatus 10 in the above embodiments executes operations have been described in detail in the embodiments related to the method, and will not be explained here in detail.

The communication apparatus 10 provided in the above embodiment of the present disclosure achieves same or similar beneficial effects as the transmission method for a PRACH provided in the above some embodiments, which will be not repeated herein.

Referring to FIG. 11, FIG. 11 is another schematic structural diagram of a communication apparatus 1000 provided by an embodiment of the present disclosure. The communication apparatus 1000 may be a network-side device or a terminal device; the communication apparatus 1000 may also be a chip, a chip system, a processor, etc., that supports the network-side device to implement the above methods, etc. ; the communication apparatus 1000 may also be a chip, a chip system, a processor, etc., that supports the terminal device to implement the above methods. The communication apparatus 1000 may be configured to implement the methods described in the above method embodiments, which may specifically refer to the description in the above method embodiments.

The communication apparatus 1000 may include one or more processors 1001. The processors 1001 may be general-purpose processors, special-purpose processors, etc. For example, the processors may be baseband processors or central processing units. The baseband processor may be configured to process a communication protocol and communication data, and the central processing unit may be configured to control the communication apparatus (for example, a base station, a baseband chip, a terminal device, a terminal device chip, a DU, a CU, etc.), execute a computer program, and process data of the computer program.

Optionally, the communication apparatus 1000 may further include one or more memories 1002. The one or more memories 1002 may store a computer program 1004, and the processors 1001 execute the computer program 1004 to cause the communication apparatus 1000 to execute the methods described in the above method embodiments. Optionally, the memories 1002 may further store data. The communication apparatus 1000 and the memories 1002 may be separately configured, or may be integrated together.

Optionally, the communication apparatus 1000 may further include a transceiver 1005 and an antenna 1006. The transceiver 1005 may be referred to as a transceiving unit, a transceiving machine, a transceiving circuit, etc., and is configured to implement a transceiving function. The transceiver 1005 may include a receiver and a transmitter. The receiver may be referred to as a receiving machine, a receiving circuit, etc., and is configured to implement a receiving function. The transmitter may be referred to as a sending machine, a sending circuit, etc., and is configured to implement a sending function.

Optionally, the communication apparatus 1000 may further include one or more interface circuits 1007. The interface circuits 1007 are configured to receive code instructions and transmit the code instructions to the processor 1001. The processor 1001 executes the code instructions to cause the communication apparatus 1000 to execute the methods described in the above method embodiments.

The communication apparatus 1000 is a terminal device. The processor 1001 is configured to execute the step S21 in FIG. 2, the step S31 in FIG. 3, the step S41 in FIG. 4, the step S51 in FIG. 5, and the step S61 in FIG. 6. The transceiver 1005 is configured to execute the step S22 in FIG. 2, the step S32 in FIG. 3, the step S42 in FIG. 4, the step S52 in FIG. 5, and the step S62 in FIG. 6.

The communication apparatus 1000 is a network-side device. The processor 1001 is configured to execute the step S71 in FIG. 7 and the step S81 in FIG. 8.

In an implementation, the processor 1001 may include a transceiver for implementing the receiving and sending functions. For example, the transceiver may be a transceiving circuit, an interface, or an interface circuit. The transceiving circuit, the interface, or the interface circuit for implementing the receiving and sending functions may be separate or integrated together. The above transceiving circuit, interface, or interface circuit may be configured to read and write codes/data, or the above transceiving circuit, interface, or interface circuit may be configured to transmit or transfer signals.

In an implementation, the processor 1001 may store a computer program 1003, and the computer program 1003 is executed by the processor 1001, so that the communication apparatus 1000 may execute the methods described in the above method embodiments. The computer program 1003 may be fixed in the processor 1001, and in this case, the processor 1001 may be implemented by hardware.

In an implementation, the communication apparatus 1000 may include a circuit, and the circuit may implement sending, receiving, or communicating functions in the above method embodiments. The processor and transceiver described in the present disclosure may be implemented on integrated circuits (ICs), analog ICs, radio frequency integrated circuits (RFICs), mixed signal ICs, application specific integrated circuits (ASICs), printed circuit boards (PCBs), electronic devices, etc. The processor and transceiver may also be fabricated with various IC process technologies, such as a complementary metal oxide semiconductor (CMOS), an n-metal oxide semiconductor (NMOS), a p-metal oxide semiconductor (positive channel metal oxide semiconductor, PMOS), a bipolar junction transistor (BJT), a bipolar CMOS (BiCMOS), a silicon germanium (SiGe), a gallium arsenide (GaAs), etc.

The communication apparatus described in the above embodiments may be a terminal device, but a scope of the communication apparatus described in the present disclosure is not limited thereto, and a structure of the communication apparatus may not be limited by FIG. 11. The communication apparatus may be a separate device or may be a part of a larger device. For example, the communication apparatus may be:
(1) a separate integrated circuit IC, chip, or chip system or subsystem;
(2) a set of one or more ICs; optionally, the set of ICs may also include a storage component configured to store data and a computer program;
(3) an ASIC, for example, a modem;
(4) a module that may be embedded within other devices;
(5) a receiving machine, a terminal device, an intelligent terminal device, a cellular phone, a wireless device, a handset, a mobile unit, an in-vehicle device, a network-side device, a cloud device, an artificial intelligence device, etc. ; or
(6) other apparatuses, etc.

For a case in which the communication apparatus may be a chip or a chip system, referring to FIG. 12, FIG. 12 is a structural diagram of a chip provided in an embodiment of the present disclosure.

The chip 1100 includes a processor 1101 and an interface 1103. There may be one or more processors 1101, and there may be multiple interfaces 1103.

For the case in which the chip is configured to implement functions of the terminal device in the embodiments of the present disclosure,
the interface 1103 is configured to receive code instructions and transmit the code instructions to the processor; and
the processor 1101 is configured to execute the code instructions to execute the transmission method for a PRACH described in the above some embodiments.

For the case in which the chip is configured to implement functions of the network-side device in the embodiments of the present disclosure,
the interface 1103 is configured to receive code instructions and transmit the code instructions to the processor; and
the processor 1101 is configured to execute the code instructions to execute the transmission method for a PRACH described in the above some embodiments.

Optionally, the chip 1100 further includes a memory 1102, and the memory 1102 is configured to store a necessary computer program and data.

Those skilled in the art may also understand that various illustrative logical blocks and steps listed in the embodiments of the present disclosure may be implemented by using electronic hardware, computer software, or a combination of the two. Whether such functions are implemented by hardware or software depends on specific applications and design requirements of an overall system. Those skilled in the art may use various methods to implement the functions for each specific application, but this implementation should not be understood as going beyond the protection scope of the embodiments of the present disclosure.

An embodiment of the present disclosure further provides a transmission system for a PRACH. The system includes the communication apparatus as the terminal device and the communication apparatus as the network-side device in the above embodiments of FIG. 9, or the system includes the communication apparatus as the terminal device and the communication apparatus as the network-side device in the above embodiment of FIG. 11.

The present disclosure further provides a readable storage medium storing instructions. When the instructions are executed by a computer, functions of any one of the above method embodiments are implemented.

The present disclosure further provides a computer program product. When the computer program product is executed by a computer, the functions of any one of the above method embodiments are implemented.

In the above embodiments, it may be implemented in whole or in part by software, hardware, firmware, or any combination thereof. When implemented in software, it may be implemented in whole or in part in the form of a computer program product. The computer program product includes one or more computer programs. When the computer programs are loaded and executed by a computer, the processes or functions according to embodiments of the present disclosure are generated in whole or in part. The computer may be a general purpose computer, a special purpose computer, a computer network, or other programmable apparatus. The computer programs may be stored in a computer readable storage medium or transmitted from one computer readable storage medium to another computer readable storage medium. For example, the computer programs may be transmitted from a website site, computer, server, or data center to another website site, computer, server, or data center by a wired (for example, a coaxial-cable, a fiber, a digital subscriber line (DSL)) or wirelessly (for example, infrared, wireless, microwave, etc.) manner. The computer readable storage medium may be any available medium that can be accessed by a computer or may be a data storage device, such as a server, data center, or the like, including one or more integrated available mediums. The available medium may be a magnetic medium (for example, a floppy disk, a hard disk, a magnetic tape), an optical medium (for example, a digital video disc (DVD)), or a semiconductor medium (for example, a solid state disk (SSD)), etc.

Those skilled in the art may understand that various numerical numbers such as “first” and “second” involved in the present disclosure are only for distinguishing for the convenience of description and are not intended to limit the scope of the embodiments of the present disclosure, and do not also represent an early-later sequence.

“At least one” in the present disclosure may also be described as one or more, and “a plurality of/multiple” may be two, three, four, or more, which is not limited in the present disclosure. In the embodiments of the present disclosure, for a kind of technical features, technical features in the kind of technical features are distinguished by “first”, “second”, “third”, “A”, “B”, “C”, and “D”, etc., and there is no an early-later sequence or a large-mall sequence among the technical features described by “first”, “second”, “third”, “A”, “B”, “C”, and “D”.

The correspondence relationships shown in each table in the present disclosure may be configured or predefined. Values of the information in each table are merely examples, and may be configured as other values, which is not limited in the present disclosure. When configuring correspondence relationships between the information and each parameter, it is not necessarily required to configure all the correspondence relationships shown in each table. For example, correspondence relationships shown in certain rows may also not be configured in the tables in the present disclosure. For another example, appropriate deformation adjustment may be executed based on the above tables, for example, splitting, merging, etc. A name of a parameter shown by a title in each of the above tables may also be another name that may be understood by the communication apparatus, and a value or a representation manner of the parameter may also be another value or representation manner that may be understood by the communication apparatus. During implementation of each of the above tables, other data structures may also be used, for example, an array, a queue, a container, a stack, a linear table, a pointer, a linked list, a tree, a graph, a structure body, a class, a heap, a hashing table, a hash table, etc., may be used.

Predefinition in the present disclosure may be understood as defining, pre-defining, storing, pre-storing, pre-negotiating, pre-configuring, curing, or pre-firing.

Those skilled in the art may realize that the units and algorithm steps of each example described in connection with the embodiments disclosed herein can be implemented in electronic hardware, or a combination of computer software and electronic hardware. Whether these functions are executed in hardware or software depends on the specific application and the design constraint condition of the technical solution. Professional technicians may use different methods to implement the described functions for each specific application, but such implementation should not be considered to be beyond the scope of the present disclosure.

Those skilled in the art may clearly understand that for the convenience and conciseness of the description, the specific working processes of the system, apparatus, and unit described above may refer to the corresponding processes in the aforementioned method embodiments, which will not be repeated here.

The above description is only specific implement manner of the present disclosure, and the protection scope of the present disclosure is not limited thereto. Any alteration or substitution that may be easily conceived by any those skilled in the art within the technical scope disclosed by the present disclosure shall fall within the protection scope of the present disclosure. Therefore, the protection scope of the present disclosure shall be subject to the protection scope of the claims.

By implementing the embodiment of the present disclosure, the terminal equipment determines the number of repetitions of the PRACH and executing the PRACH transmission according to the number of repetitions. Therefore, the terminal device can implement the PRACH transmission for the number of repetitions, to enhance coverage of the PRACH.

In a sixth aspect, an embodiment of the present disclosure provides a communication apparatus. The communication apparatus has a part or all of functions of the terminal device implementing the method in the above first aspect. For example, functions of the communication apparatus may have functions in a part or all of the embodiments of the present disclosure, or may have functions separately implementing any embodiment of the present disclosure. The functions may be implemented by hardware, or may be implemented by hardware executing corresponding software. The hardware or software includes one or more units or modules corresponding to the above functions.

In an implementation, a structure of the communication apparatus may include a transceiving module. The transceiving module is configured to support communication between the communication apparatus and other devices. The communication apparatus may further include a storage module, where the storage module is configured to be coupled to the transceiving module and a processing module, and stores a computer program and data that are necessary for the communication apparatus.

For example, the processing module may be a processor, the transceiving module may be a transceiver or a communication interface, and the storage module may be a memory.

In an implementation, the communication apparatus includes: a processing module, configured to determine the number of repetitions of a PRACH; and a transceiving module, configured to execute PRACH transmission according to the number of repetitions.

In a seventh aspect, an embodiment of the present disclosure provides another communication apparatus. The communication apparatus has a part or all of functions of the network-side device implementing the method example in the above second aspect. For example, functions of the communication apparatus may have functions in a part or all of the embodiments of the present disclosure, or may have functions separately implementing any embodiment of the present disclosure. The functions may be implemented by hardware, or may be implemented by hardware executing corresponding software. The hardware or software includes one or more units or modules corresponding to the above functions.

In an implementation, a structure of the communication apparatus may include a transceiving module, and the transceiving module is configured to support communication between the communication apparatus and other devices. The communication apparatus may further include a storage module, where the storage module is configured to be coupled to the transceiving module and a processing module, and stores a computer program and data that are necessary for the communication apparatus.

In an implementation, the communication apparatus includes: a processing module, configured to instruct the number of repetitions of a PRACH to a terminal device, and receive data of PRACH transmission executed by the terminal device according to the number of repetitions.

In an eight aspect, an embodiment of the present disclosure provides a communication apparatus. The communication apparatus includes a processor, and the processor, when invoking a computer program in a memory, executes the method in the first aspect.

In a ninth aspect, an embodiment of the present disclosure provides a communication apparatus. The communication apparatus includes a processor, and the processor, when invoking a computer program in a memory, executes the method in the second aspect.

In a tenth aspect, an embodiment of the present disclosure provides a communication apparatus. The apparatus includes a processor and an interface circuit. The interface circuit is configured to receive code instructions and transmitting the code instructions to the processor, and the processor is configured to execute the code instructions to cause the apparatus to execute the method in the first aspect.

In an eleventh aspect, an embodiment of the present disclosure provides a communication apparatus. The apparatus includes a processor and an interface circuit. The interface circuit is configured to receive code instructions and transmitting the code instructions to the processor, and the processor is configured to execute the code instructions to cause the apparatus to execute the method in the second aspect.

In a twelfth aspect, an embodiment of the present disclosure provides a communication system. The system includes the communication apparatus in the third aspect and the communication apparatus in the fourth aspect, the system includes the communication apparatus in the fifth aspect and the communication apparatus in the sixth aspect, the system includes the communication apparatus in the seventh aspect and the communication apparatus in the eighth aspect, or the system includes the communication apparatus in the ninth aspect and the communication apparatus in the tenth aspect.

In a thirteenth aspect, an embodiment of the present disclosure provides a readable storage medium, configured to store instructions used for the above network-side device. When the instructions are executed, the network-side device executes the method in the second aspect.

In a fourteenth aspect, the present disclosure further provides a computer program product including a computer program. When the computer program is executed by a computer, the computer executes the method in the first aspect.

In a fifteenth aspect, the present disclosure further provides a computer program product including a computer program. When the computer program is executed by a computer, the computer executes the method in the second aspect.

In a sixteenth aspect, the present disclosure provides a chip system. The chip system includes at least one processor and an interface, and is configured to support the terminal in implementing the functions involved in the first aspect, for example, determining or processing at least one of data and information involved in the above methods. In a possible design, the chip system further includes a memory, and the memory is configured to store a computer program and data that are necessary for the terminal. The chip system may be composed of a chip, or may include a chip and other discrete components.

In a seventeenth aspect, the present disclosure provides a chip system. The chip system includes at least one processor and an interface, and is configured to support the network-side device in implementing the functions involved in the second aspect, for example, determining or processing at least one of data and information involved in the above methods. In a possible design, the chip system further includes a memory, and the memory is configured to store a computer program and data that are necessary for the network-side device. The chip system may be composed of a chip, or may include a chip and other discrete components.

In an eighteenth aspect, the present disclosure provides a computer program. When the computer program is executed by a computer, the computer executes the method in the first aspect.

In a nineteenth aspect, the present disclosure provides a computer program. When the computer program is executed by a computer, the computer executes the method in the second aspect.

1. A transmission method for a physical random access channel (PRACH), applied to a terminal device and comprising:
determining a number of repetitions of the PRACH; and
performing PRACH transmission according to the number of repetitions;
wherein the determining a number of repetitions of the PRACH comprises one of:
determining a candidate value set; receiving indication information from a network device, and selecting, according to the indication information, the number of repetitions of the PRACH from the candidate value set; or
obtaining synchronous signal block (SSB) information selected by the terminal device, wherein each piece of SSB information corresponds to information of number of repetitions; and obtaining information of number of repetitions corresponding to the selected SSB information as the number of repetitions of the PRACH.

2. The method of claim 1, wherein the determining a number of repetitions of the PRACH comprises:
determining the number of repetitions of the PRACH according to a protocol provision.

3. (canceled)

4. The method of claim 1, wherein the method further comprises:
determining the number of repetitions of the PRACH as a preset value, wherein the indication information indicates that the number of repetitions of the PRACH is the preset value.

5. (canceled)

6. The method of claim 1, wherein the method further comprises:
obtaining a random access configuration table comprising information of number of repetitions; and
obtaining, according to an index value indicated by the indication information, the number of repetitions from the random access configuration table.

7. The method of claim 1, wherein the indication information is carried by a master information block (MIB) of a physical broadcast channel (PBCH), a system information block (SIB1), or an additional payload of the PBCH.

8. The method of claim 7, wherein the indication information is carried in an existing bit field of the MIB or the SIB1, or carried in an extended bit field of the MIB or the SIB1.

9. (canceled)

10. The method of claim 1, wherein the determining a number of repetitions of the PRACH further comprises:
obtaining a preamble of the terminal device, wherein each preamble corresponds to information of number of repetitions; and
obtaining information of number of repetitions corresponding to the preamble as the number of repetitions of the PRACH.

11. The method of claim 1, wherein the determining a number of repetitions of the PRACH further comprises:
obtaining a random access occasion (RO) of the terminal device; wherein each of ROs corresponds to information of number of repetitions; and
obtaining information of number of repetitions corresponding to the RO as the number of repetitions of the PRACH.

12. A transmission method for a physical random access channel (PRACH), applied to a network-side device and comprising:
indicating a number of repetitions of the PRACH to a terminal device; and
receiving data of PRACH transmission performed by the terminal device according to the number of repetitions;
wherein the indicating a number of repetitions of the PRACH to a terminal device comprises:
sending indication information to the terminal device, wherein the indication information is configured for the terminal device to select the number of repetitions from a candidate value set.

13. (canceled)

14. The method of claim 12, wherein the indicating a number of repetitions of the PRACH to a terminal device further comprises:
sending the indication information to the terminal device, so as to indicate, according to a preset value indicated by the indication information, that the number of repetitions of the PRACH is the preset value.

15. (canceled)

16. The method of claim 12, wherein the indicating a number of repetitions of the PRACH to a terminal device further comprises:
sending the indication information indicating an index value to the terminal device, so as to enable obtaining, according to the index value, the number of repetitions from a random access configuration table.

17. The method of claim 12, wherein the indication information is carried by a master information block (MIB) of a physical broadcast channel (PBCH), a system information block (SIB1), or an additional payload of the PBCH;
wherein the indication information is carried in an existing bit field of the MIB or the SIB1, or carried in an extended bit field of the MIB or the SIB1.

18.-20. (canceled)

21. A communication apparatus, comprising a processor and a memory, wherein the memory stores a computer program, and the processor executes the computer program stored in the memory, to:
determine a number of repetitions of the PRACH; and
perform PRACH transmission according to the number of repetitions;
wherein the processor executes the computer program stored in the memory, to perform one of:
determining a candidate value set; receiving indication information from a network device, and selecting, according to the indication information, the number of repetitions from the candidate value set; or
obtaining synchronous signal block (SSB) information selected by the terminal device, wherein each piece of SSB information corresponds to information of number of repetitions; and obtaining information of number of repetitions corresponding to the selected SSB information as the number of repetitions of the PRACH.

22. A communication apparatus, comprising: a processor and a memory;
wherein the memory stores a computer program, and the processor executes the computer program stored in the memory, to cause the apparatus to execute the method of claim 12.

23. A non-transitory computer readable storage medium, configured to store instructions, wherein when the instructions are executed, the method of claim 1 is implemented.
